(19) United States
(12) Patent Application Publication
(10) Pub. No.: US 2013/0238420 A1
(43) Pub. Date: Sep. 12, 2013

(54) Systems and Methods to Facilitate Keyword Portfolio Management

(71) Applicant: INNOVATION INTERACTIVE, NEW YORK, NY (US)

(72) Inventors: JAMES ROGER BARNETTE, JR., ATLANTA, GA (US); ERIC J. CARLYLE, ATLANTA, GA (US); CRAIG R. POHAN, HOBOKEN, NJ (US)

(73) Assignee: INNOVATION INTERACTIVE, NEW YORK, NY (US)

(21) Appl. No.: 13/793,554

(22) Filed: Mar. 11, 2013

Related U.S. Application Data
(62) Division of application No. 11/598,313, filed on Nov. 13, 2006, now abandoned.
(60) Provisional application No. 60/736,275, filed on Nov. 14, 2005.

(51) Int. Cl. G06Q 30/02

(52) U.S. Cl. CPC G06Q 30/0243
USPC 705/14.42

(57) ABSTRACT

According to some embodiments, advertising response information is collected for a search keyword, the advertising response information being associated with a plurality of users and a plurality of ranked positions in a list of advertisements presented to users. A non-linear function may then be performed on the advertising response information to predict advertising response information for at least one rank position.

### CROSS-REFERENCE TO RELATED APPLICATIONS

The present application claims priority under 35 U.S.C. §119(e) to (i) U.S. Provisional Patent Application No. 60/736,275 entitled “Systems and Methods to Facilitate Keyword Portfolio Management” and filed on Nov. 14, 2005, and U.S. patent application Ser. No. 11/598,313 entitled “Systems and Methods to Facilitate Keyword Portfolio Management” filed on Nov. 13, 2006. The entire content of that application is incorporated herein by reference.

### FIELD

The present invention relates to search keywords. In particular, some embodiments of the present invention relate to systems and methods to facilitate keyword portfolio management associated with search-based advertisements.

### BACKGROUND

A user may search for information via a communication network. For example, a user interested in a particular topic might enter one or more search words associated with that topic into a search engine. A platform (e.g., a web server) supporting the search engine may then provide the user with one or more search results associated with his or her search words. For example, a list of web pages that contain the search words might be displayed to the user.

In some cases, the search platform will also display one or more advertisements to the user. For example, a list of advertisements related to a user's search could be displayed to the user along with his or her search results. Moreover, an advertiser may provide payment to the search platform in exchange for having advertisements displayed to users who are searching for particular types of information (e.g., a store that sells televisions might pay to have an advertisement displayed to users who are searching for “big screen TVs”). Note that advertisers may pay different amounts to the search engine based on which search words will trigger display of an advertisement and/or where the advertisement is displayed with respect to other advertisements. For example, an advertiser might pay a premium to have an advertisement displayed first in a list of advertisements.

### BRIEF DESCRIPTION OF THE DRAWINGS

FIG. 1 is a block diagram overview of a system according to some embodiments of the present invention.

FIG. 2 illustrates a user display according to some embodiments of the present invention.

FIG. 3 is a block diagram overview of a keyword portfolio management engine according to some embodiments of the present invention.

FIG. 4 is a block diagram overview of a prediction engine according to some embodiments of the present invention.

FIG. 5 is a graph illustrating a relationship between advertising ranks and predicted impressions according to some embodiments of the present invention.

FIG. 6 is a graph illustrating a relationship between observed ranks, observations, and response rates according to some embodiments of the present invention.

FIG. 7 is a flow chart of a method according to some embodiments of the present invention.

FIG. 8 is a block diagram of a keyword portfolio management engine according to some embodiments of the present invention.

FIG. 9 is a graph illustrating a relationship between ranks, clicks, and response rates according to some embodiments of the present invention.

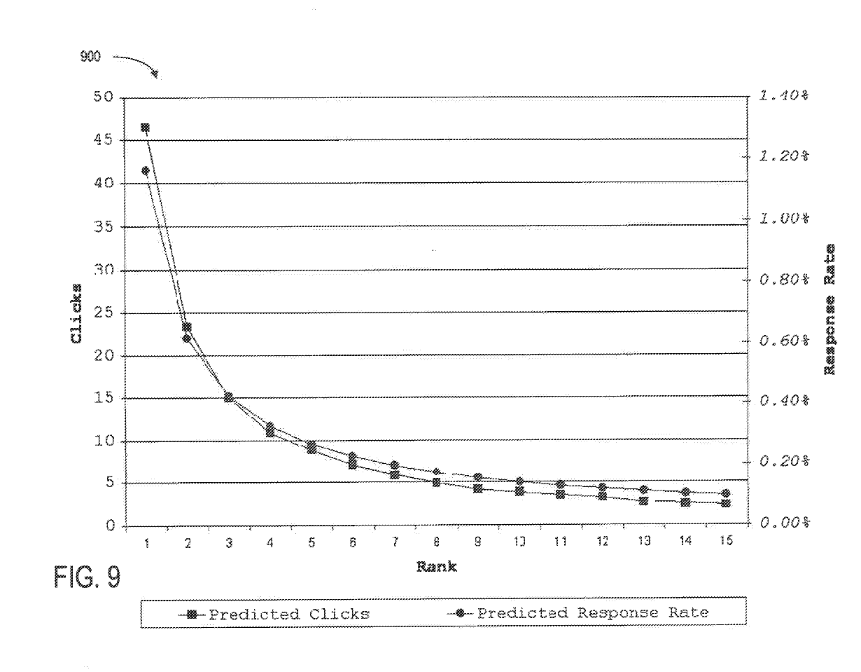

FIG. 10 is a flow chart of a method according to some embodiments of the present invention.

### DETAILED DESCRIPTION

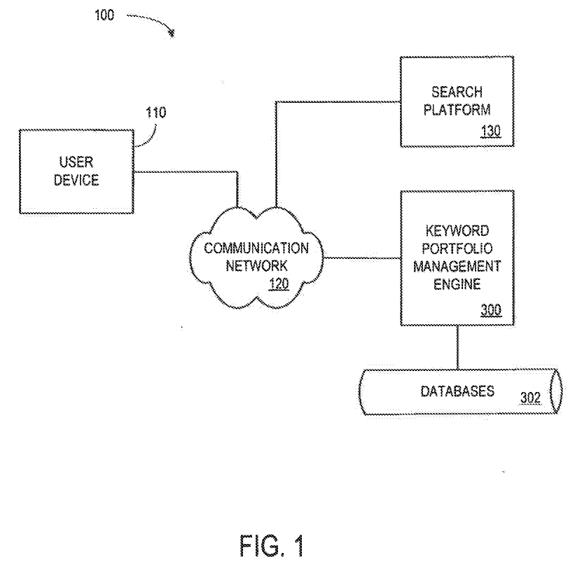

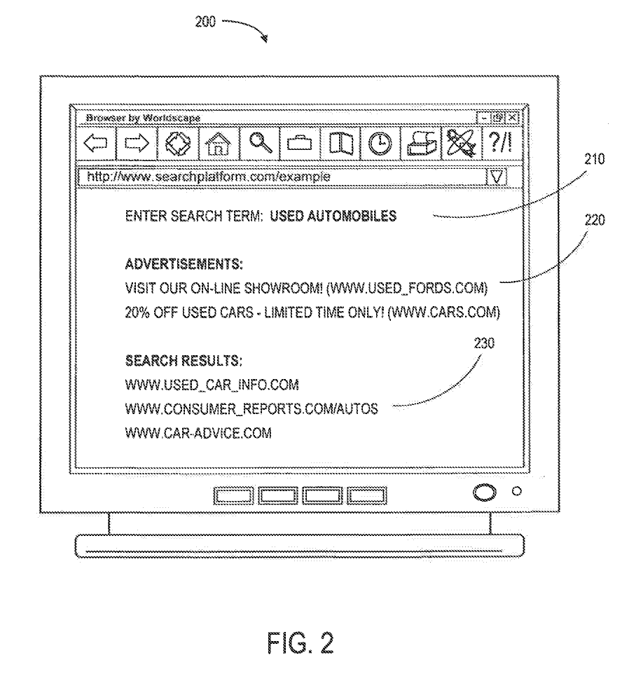

A user may search for information via a communication network. For example, FIG. 1 is a block diagram overview of a system 100 according to some embodiments of the present invention. In this case, a user might enter one or more search terms via a user device 110, such as a Personal Computer (PC). The user device 110 may transmit the search terms to a search platform 130 via a communication network 120. The search platform 130 might be associated with, for example, a web site accessed via the Internet. FIG. 2 illustrates such a web site having a user display 200 with an area 210 where a user can enter one or more search terms.

As used herein, devices (such as the user device 110 and the search platform 130) may communicate via the communication network 120, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that the devices shown in FIG. 1 need not be in constant communication. For example, the user device 110 may only communicate with the search platform 130 on an as-needed basis. In some embodiments, for example, the user device 110 may be a PC that intermittently utilizes a dial-up connection to the Internet via an Internet Service Provider (ISP). In other embodiments the user device 110 may be in constant and/or high-speed communication with the search platform 130 through the use of any known or available connection device such as a cable or Digital Subscriber Line (DSL) modem. According to some embodiments, the communication network 120 may be or include multiple networks of varying type, configuration, size, and/or functionality.

Although a single user device 110 and a single search platform 130 are illustrated in FIG. 1, any number of these devices may be included in the system 100. Similarly, any number of the other devices described herein may be included in the system 100 according to embodiments of the present invention. A single search platform 130 may, for example, be in communication with multiple user devices 110. In some embodiments, multiple search platforms 130 and/or related devices may provide various information such as advertisements and/or web pages to one or more user device 110.

The user device 110 and the search platform 130 may be any devices capable of performing various functions described herein. The user device 110 may be, for example: a PC, a portable computing device such as a Personal Digital Assistant (PDA), an interactive television device, or any other appropriate storage and/or communication device. The search platform 130 may be, for example, a Web server that provides web pages for a browser application of the user device 110 (e.g., the INTERNET EXPLORER® browser application available from MICROSOFT®).

The search platform 130 may then provide the user device 110 with one or more results associated with his or her search words. For example, the display 200 of FIG. 2 includes an area 230 where a list of potentially relevant web pages can be displayed to the user.

In some cases, the search platform 120 will also display one or more “advertisements” to the user. As used herein, the term “advertisement” may refer to, for example, text or graphical information related to a product, service, or business. For example, as illustrated by area 220 of FIG. 200, a list of advertisements related to a user's search could be displayed to the user along with his or her search results 230. Moreover, an advertiser may provide payment to the search platform 130 in exchange for having advertisements displayed to users who are searching for particular types of information (e.g., an online pharmacy might pay to have an advertisement displayed to users who are searching for “cold remedies”). Note that in some cases, advertisers might pay different amounts to the search platform 130 based on which search terms will trigger display of an advertisement and/or where the advertisement is displayed in the area 230. For example, an advertiser might pay a premium to have an advertisement displayed first in the area 230.

In some cases, different advertisers are willing to pay different amounts of money in exchange for the display of advertisements to users. For example, a first advertiser might be willing to pay three cents for every one thousand advertisements that are displayed, referred to as the cost-per-thousand value (CPM), while a second advertiser is only willing pay two cents CPM. In this case, an advertising service might select advertisements from the first advertiser more often than it does from the second advertiser (to increase revenue).

In other cases, an advertiser may provide payment based on an action performed by a user (instead of for merely displaying an advertisement to the user). For example, an advertiser might pay five cents for every user that clicks on a particular graphical advertisement, referred to as the Cost.Per.Click value (CPC). A search platform 130 may, in some cases, select one of a number of different advertisements to be displayed to a user based on bids provided by advertisers.

The system 100 may further include a keyword portfolio management engine 300 that may help advertisers interact with the search platform 130. The keyword portfolio management engine 300 might comprise, for example, a web-based software platform that lets search engine marketers manage various aspects of a paid search campaigns in one convenient location. Some embodiment of the keyword portfolio management engine 300 might be associated with a suite of software applications that include search term (or “keyword”) development, bid optimization (or any other bid facilitation), and/or reporting and analytic capabilities for advertisers.

According to some embodiments, the keyword portfolio management engine 300 may provide a versatile tool for improving the business objectives of a pay per click campaign. The keyword portfolio management engine 300 may, for example, let an advertiser establish an online advertising campaign and optimizing or otherwise improving the campaign might require entry of only a few parameters which are collected via a web interface associated with the keyword portfolio management engine 300.

After implementation, the keyword portfolio management engine 300 may automatically adjust and update the campaign to achieve the desired business objectives. Note that the keyword portfolio management engine 300 may, according to some embodiments, manage paid search campaign all across several different pay per click engines. Note that a single advertiser might establish multiple keywords in the same campaign and/or establish multiple campaigns. According to some embodiments, the keyword portfolio management engine 300 settings are managed at the campaign level. Such an approach may give advertisers the transparency, power, and flexibility necessary to manage large, complex paid search campaigns to multiple business goals.

To help manage a campaign, the keyword portfolio management engine 300 may receive from an advertiser a definition of a revenue structure and/or an optimization type for that campaign. For example, a revenue structure might be associated with a conversion percentage and/or an average transaction amount, which might be automatically determined via tracking technology or manually received from an advertiser for a selected campaign. As another example, a revenue structure might be associated with a net profit percentage or base click value (e.g., to let advertisers include an additional value for each click from pay per click that is not garnered from traditional internal or external tracking sources). Note that a revenue structure might be implemented at a keyword level or at any other level.

Examples of campaign optimizations targets might include clicks, which could improve a number of clicks for a target budget within bounds of net revenue—the equivalent of driving a maximum number of clicks for a given budget. As another example, an optimization type might be associated with acquisitions that could improve a number of customer acquisitions (or conversions) for a targeted budget (e.g., to reduce a cost per acquisition per a given budget). As still other examples, an advertiser might want to improve net revenue (e.g., based on revenue/base click value/cost) for a targeted budget (e.g., to improve a return on advertising spend per a given budget) or profit (e.g., based on revenue/net profit percentage/base click value/cost).

The keyword portfolio management engine 300 may manage a campaign budget associated with an advertiser. For example, a campaign budget might be associated with a daily amount that the advertiser wishes to spend per day across all search engine platforms 130 represented in a campaign.

Once initial settings are entered for an advertiser, the keyword portfolio management engine 300 may show a set of predicted metrics selected campaign prior to initial optimization. The advertiser may also preview initial bids for each keyword in the campaign and readjust revenue structure or optimizer settings to examine how changes affect the campaign or keyword level results. When an advertiser is satisfied with the predicted results, the keyword portfolio management engine 300 can begin to continually monitor the marketplace and adjust bids for the campaign so as to fulfill the desired settings recorded in the system.

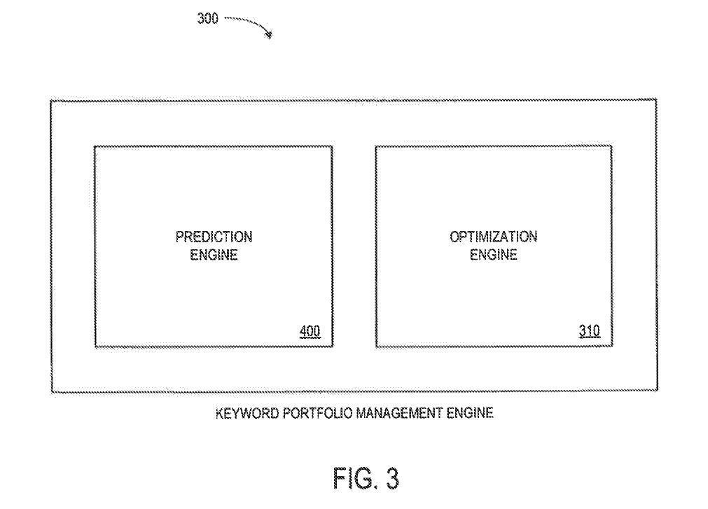

FIG. 3 is a block diagram overview of a keyword portfolio management engine 300 according to some embodiments of the present invention. The keyword portfolio management engine 300 may include, for example, bid control, tracking mechanisms and/or reporting platforms. According to some embodiments, the keyword portfolio management engine 300 includes a prediction engine 400 that may use non-linear spaced statistical modeling to develop a forecast of expected performance of various keywords across potential “ranks” available on a search platform 130.

As used herein, a set of advertisements may be displayed as a “ranked” list to users. For example, referring to FIG. 2, two advertisements are displayed in area 220, with “visit our on-line showroom!” having a rank of “1” (because it is displayed at the top of the area 220) and “20% off used cars—limited time only!” having a rank of “2” (because it is displayed below the first ranked advertisement). Note that any number of ranked positions may be available. Moreover, other factors may determine the order in which advertisements are ranked (e.g., the might be ranked from left to right along a display or from largest to smallest).

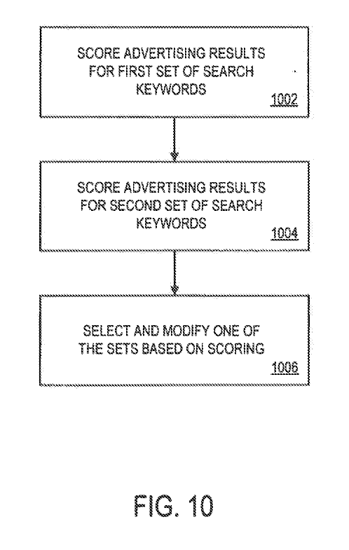

The keyword portfolio management engine 300 may further include an optimization engine 310 that uses modified genetic algorithms to find appropriate bid/rank settings for each keyword within a campaign for a given set of business objectives (e.g., as described with respect to FIG. 10). The optimization engine 310 might, for example, combine the forecasted keyword/rank combinations to improve a defined business objective subject to a daily budget constraint. By way of example only, the keyword portfolio management engine 300 might manage a campaign containing 1,500 keywords across the GOOGLE® and YAHOO® search platforms 130. In such a case, the keyword portfolio management engine 300 might develop thousands of individual keyword/rank predictions utilizing contemporaneous data and intelligently search through a substantially larger number of portfolio combinations.

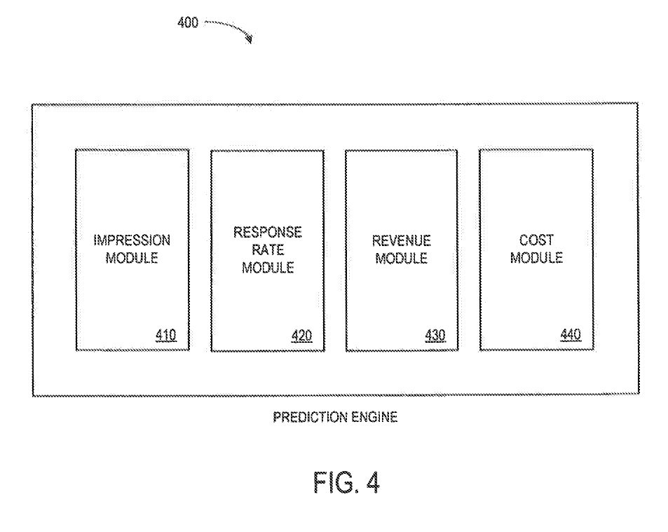

Referring now to FIG. 4, the prediction engine 400 may use historical and/or real-time information for a keyword to develop a forecast for the relative performance of that keyword across a range of ranks. It may, in some cases, be helpful to develop forecasts from limited information about the relative value of keyword/rank combinations (e.g., when there is little or no data. The prediction engine 400 may, according to some embodiments, use four separate forecasting modules to help define inputs to pay per click equations: an impression model 410, a response rate module 420, a revenue model 430, and/or a cost module 440.

The impression model 410, may be associated with, for example, “impressions” that represent a number of times that a keyword pay per click ad appears during a reporting day of a search engine platform 130. In some embodiments, the impression module 410 automatically polls search engine platforms 130 that report a total number of impressions for each keyword in a campaign (and this information may be warehoused, for example, in one or more databases 302).

In some cases, a daily impression history for individual keywords may indicate that, holding all other things constant, the number of impressions per day decreases as the relative rank of a keyword decreases. For example a keyword with a rank of 1 might receive on average 36% more impressions than a keyword of rank 5. Additionally, such a declining impression structure may be statistically different between search engine platforms. Moreover, some search terms, and therefore keywords, may have an inherent momentum. While many search terms might display stable patterns of impressions over long periods of time, many search terms display seasonal or other abnormal patterns of impressions.

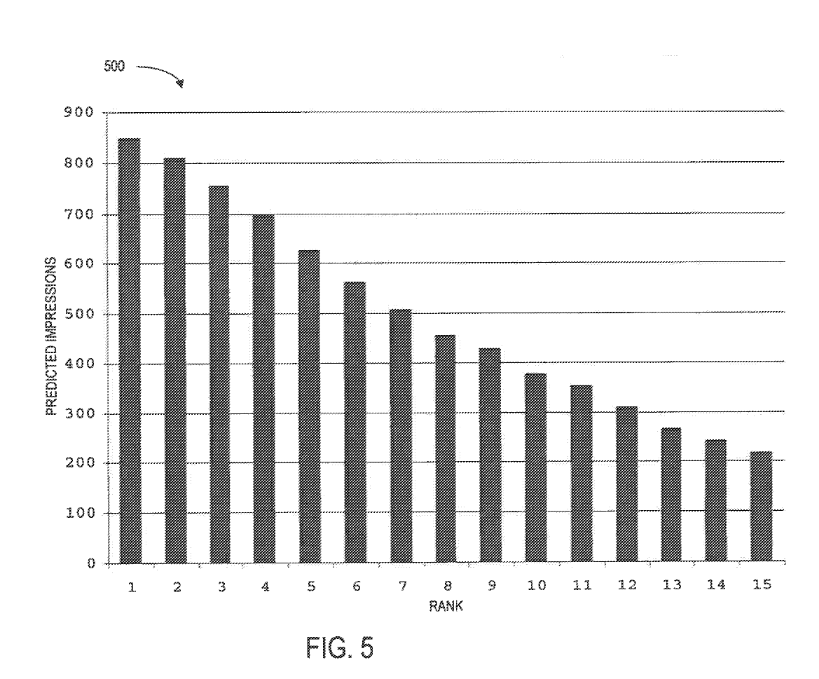

The impression module 410 of the prediction engine 400 may integrate these insights into a statistical model that forecasts the impressions of a keyword on a search engine across the entire range of ranks as illustrated by the graph 500 of FIG. 5.

The response rate module 420 of the prediction engine 400 may examine the response rate or click through rate for a keyword across a set of potential ranks. Such an examination may significantly impact a direction and/or magnitude of a campaign. That is, the response rate may be a significant driver in the revenue structure and cost functions of the optimized campaign.

According to some embodiments, the prediction engine 400 collects the reported clicks from the search engine platforms 130 and then calculates observed response rates with the same periodicity as impressions. Note that such a database of impressions and clicks could represent millions of daily and intraday keyword/rank comparisons. This data may provide numerous insights into dynamics that drive response rates for the keywords of a pay per click campaign.

Because pay per click rank may, at least in part, determine response rates for any particular keyword, the higher a keyword is ranked may be associated with a higher response rate. Moreover, the slope associated with some ranks—representing a change in response rate for each change in rank—may help predict information associated with other ranks. This slope may be, in some cases, highly non-linear and can therefore be difficult to accurately model or measure using traditional statistical techniques.

Even in the face of significant changes in impressions, the proportion of searches that result in a click may be statistically constant. This result may be similarly confirmed in the marketplace, in that higher prices are charged for higher ranks

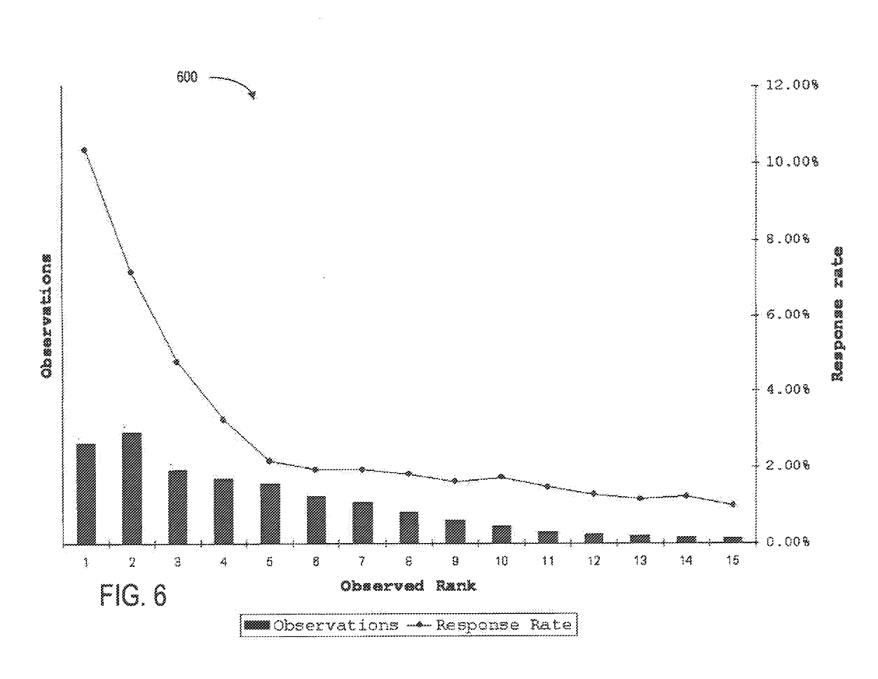

While an accurate assessment of impressions is valuable, a precise measure of response rate may be important to the success of the pay per click campaign. This is because the impressions component of a keyword generally has less influence on the magnitude (budget) than does the response rate. For example, FIG. 6 is a graph 600 illustrating a relationship between observed ranks, observations, and response rates according to some embodiments of the present invention. In general, changes in rank have relatively small changes in predicted impressions-but large changes in predicted response rates. Response rates also have an impact on the effectiveness of a keyword via its relationship with bids.

According to some embodiments of the present invention, the prediction engine 400 uses modeling technology associated with non-linear spaced statistical modeling that accurately models the shapes of response rate curves, and therefore the prediction engine 400 can make accurate forecasts where sparse or no data exists. With this accuracy, the prediction engine 400 may apply quantitative techniques to analyze the response rate/revenue structure to bid relationship and locate pricing inefficiencies that can be integrated into the pay per click campaign.

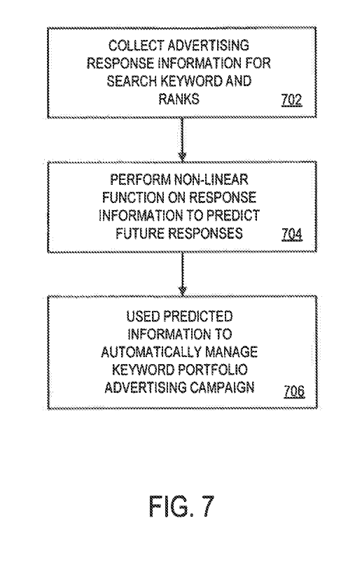

FIG. 7 is a flow chart of a method according to some embodiments of the present invention. The flow charts in FIG. 7 and the other figures described herein do not imply a fixed order to the steps, and embodiments of the present invention can be practiced in any order that is practicable. The method shown in FIG. 7 may be performed, for example, by the advertising controller 160.

At 702, advertising response information is collected for a search keyword. The advertising response information might be associated with, for example, a plurality of users and/or a plurality of ranked positions in a list of advertisements presented to users.

At 704, a nonlinear function is performed on the advertising response information to predict advertising response information for at least one rank position. The nonlinear function might be associated with, for example, a logarithmic function such as a natural log transformation or a power log transformation. Moreover, such a log transformation could be applied to either a rank position axis and/or an advertising response information axis (e.g., associated with observations, response rates, and/or click-through rates). According to some embodiments, the predicted advertising response information is further based on aggregated information associated with at least one other search keyword.

At 706, the predicted advertising response information is used to automatically manage a keyword portfolio advertising campaign. For example, a predicted response rate may be generated for a rank position (having little or no actual data available) and that rate may be used to automatically generate and submit a bid to one or more search platforms 130.

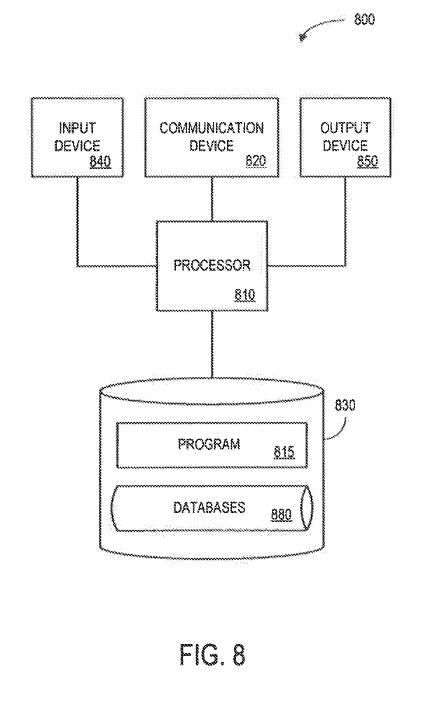

FIG. 8 is a block diagram of a keyword portfolio management engine 800 that may be, for example, descriptive of the device 300 shown in FIGS. 1 and/or 3 according to an embodiment of the present invention. The keyword portfolio management engine 800 comprises a processor 810, such as one or more INTEL® Pentium® processors, coupled to a communication device 820 configured to communicate via a communication network (not shown in FIG. 8). The communication device 820 may be used to communicate, for example, with one or more user devices 110, search platforms 130, and/or advertiser devices. The keyword portfolio management engine 800 further includes an input device 840 (e.g., a mouser and/or keyboard) and an output device 850 (e.g., a computer monitor).

The processor 810 communicates with a storage device 830. The storage device 830 may comprise any appropriate information storage device, including combinations of magnetic storage devices (e.g., a hard disk drive), optical storage devices, and/or semiconductor memory devices such as Random Access Memory (RAM) devices and Read Only Memory (ROM) devices.

The storage device 830 stores a program 815 for controlling the processor 810. The processor 810 performs instructions of the program 815, and thereby operates in accordance with any of the embodiments described herein. For example, the processor 810 may perform a non-linear function on advertising response information to predict advertising response information for at least one rank position based on information stored in databases 880 (e.g., which may include a user database, a keyword database, a historical result database, and/or an advertisement database).

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the keyword portfolio management engine 800 from another device; or (ii) a software application or module within the keyword portfolio management engine 800 from another software application, module, or any other source.

According to some embodiments, predicted advertising response in formation is further based on: (i) user information (e.g., his or her demographic information), (ii) web page information, (iii) a business type, (iv) campaign information, (v) time information (e.g., a time of day or holiday season), and/or (vi) geographic information. Moreover, a steepness of rank slopes and/or the expected response rates at the first rank position can vary significantly across keywords. According to some embodiments, the response rate curves might be categorized using campaign level designations such as: (i) is the campaign business-to-business (B2B) or business-to-consumer (B2C), (ii) is the campaign offering a product or a service? and/or (iii) is the campaign target sale/use regionalized?

Note that a majority of keywords within a campaign may have statistically similar response rate curves. In many campaigns, a small number of high traffic/highly bid competitive keywords can capture a vast majority of clicks; but the remaining keywords will often display very similar response rate curves. This is logical as most of these keywords are derivatives (geographic, extensions or descriptors) of other keyword in the campaign.

According to some embodiments, the prediction engine 400 may use a statistical algorithm which adjusts for the highly non-linear nature of the “natural” response rate curve while also adjusting for data gaps and sample sizes. The algorithm may be complimented by a statistical clustering completed via branch and bound that searches the campaign for keywords which have similar response rate histories. These keywords may then be grouped within the system into separate sub-campaigns which are modeled independently. Daily, these response rate curves may be recalculated and re-examined for statistical differences. Periodically, the response rate module 420 may collapse similar sub-campaigns to reduce the complexity of the system.

According to some embodiments, the response rate module 420 may also guide new campaigns into the marketplace using the campaign's business level clustering designations (e.g., B2B or B2C, product or service, regional or universal). Using its history of like business level designations, the response rate module 420, in the absence of specific keyword data, might apply response rate estimates calculated using the designations. As data for the campaign's keywords becomes available, the response rate module 420 may transition the campaign to be fully independent of the cluster designations. The ultimate result of the response rate module 430 and impression module 410 may thus be an accurate and reliable measure of the relative change in clicks for a change of position rank for individual keywords.

FIG. 10 is a graph 900 illustrating a relationship between ranks, clicks, and response rates according to some embodiments of the present invention. Note that a nearly linear decline in impressions multiplied by the non-linear decline in response rate may result in a corresponding nonlinear decline in predicted clicks

Once an estimate of clicks has been established, these clicks can be supplied to the revenue module 430. The revenue module 430 may, for example, be defined by the traceable revenue of the keyword and intangible value of the click. A campaign using appropriate tracking mechanisms—or utilizing a detailed ongoing data feed—may thus be allowed to engage the keyword level revenue module 430. According to another embodiment, global estimates of conversion percentages and transaction amounts may be applied to all the keywords in a campaign. Campaigns without tracking could bypass the revenue module 430 and supply global overrides for average conversion percentages and revenue per transaction.

According to some embodiments, a tracking mechanism records individual conversions/transactions on an advertiser's website at the keyword level and transmits the information back to a database. Advertiser that use tracking may be allowed to identify am unlimited number of custom transaction types such as sales, sign-ups, or leads. Each transaction type could be associated with its own revenue estimate or return actual dollar transactions.

The revenue module 430 might begin with the observation that conversion percentages and transaction amounts can be independent of the referring pay per click ads rank This independent relationship between search term and site relevance can result in conversion and transactions amounts which vary, often substantially, for each keyword in a campaign.

Also note that conversion percentages and transaction amounts for an individual keyword can be fairly consistent through time. The net result may be that a keyword has an inherent “efficiency” which carries only a marginal degree of momentum that is changed most significantly by a target web site's presentation or content.

Such generalizations, though, can be broken for keywords with low traffic patterns or, as is often found in B2B campaigns, the presence of a single high value transaction can distort the revenue structure. As a result, the revenue module 430 might implement statistical smoothing algorithms which adjust conversion percentages and average transaction amounts for sample sizes and “lumpy” revenue streams.

Because pay per click platforms vary in the transparency of their pricing structures, the cost module 440 may determine bids appropriate to obtain a rank for a keyword. For pay per click platforms with near-transparent bid structures, the cost module 440 might use the reported bids for each rank to determine the cost per click; where a rank is outside the reported bid structure, an estimate of the degrade in bids might be used to imply the continuing structure.

When the rank-to-bid relationship is substantially hidden, an estimate of the bid/rank elasticity may be created by the cost module 440 using the prevailing response rate curve as determined by the response rate module 420. That is, the cost module 440 might attempt to mimic the intrinsic value/minimum bid model which the search platform 130 may have implemented.

As a result, the prediction engine 400 may develop a portrait of a keyword across a range of ranks which could be implemented on a pay per click platform. Some embodiments of the present invention exploit keyword market inefficiencies that might be consistently present in the pay per click market—and, as a result, campaigns may be made more efficient.

A campaign might consist of hundreds or thousands of keywords, and the optimization engine 310 of FIG. 3 may, according to some embodiments, select the efficiency to magnitude relationships across the set of keywords (campaign) in a way that meets the business objectives of a campaign within a given budget.

For example, the optimization engine 310 might selecting one bid/rank choice for each keyword in a campaign produced by the prediction engine 400. The optimization engine 310 may also take a desired budget from the advertiser and attempt to improve the purposed objective (e.g., clicks, acquisitions, net revenue, and/or profit).

According to some embodiments, the optimization engine 340 implements a modified genetic algorithm. A genetic algorithm may be, for example, a structured search of a range of available solutions; this structured search uses mathematical models of chromosomes, reproduction and natural selection to guide the search to an optimal or near-optimal solution.

FIG. 11 is a flow chart of a method according to some embodiments of the present invention.

At 1002, a first set of search keywords is established and advertising results associated with the first set scored. Similarly, a second set of search keywords is established and advertising results associated with the second are scored at 1004. The second set might be established, for example, by modifying the first set. At 1006, one of the first or second sets are selected based least in part on the adverting results. The selected set may then be modified generate a third set of search keywords.

For example, a “parent” may be a potential campaign to be tested. Each parent can be defined as a string of ranks exactly equal to the number of keywords in the campaign; and each keyword in the campaign can have a defined position in the string. Initially, a rank for a position is randomly selected from the available ranks produced by the prediction engine 400 and this process may be repeated for each position in the string.

A “parent” can be evaluated to determine how well it fits the ultimate goal of the campaign and the desired budget. According to some embodiments, a goodness of fit calculation draws from the prediction engine 400 the magnitude/effectiveness of the keywords' ranks represented by the parent. In some cases, the goodness of fit algorithm attempts to punish the parent for not being close to the prescribed budget and then reward the parent for delivering total value to the campaign. Note that this calculation may be indifferent to any nonlinear relationship of the rank/bid relationships present in the individual keywords.

A series of parents, once created and evaluated via the goodness of fit, is called a “generation.” Some parents may have high goodness of fit values while others will be low (too much/little budget or very little value in the desired objective). These low performing parents can be removed from the generation. The remaining, “fit” parents, will be allowed the opportunity to combine (or mate) with other fit parents. This mating process or crossover can test the hypothesis that the head of the string of parent X when combined with the tail of the string of parent Y performs better than the original parents.

If the hypothesis is true, then the “child” is retained and the parent is discarded. In this way, the search of the available combination may directed to the better and better performing candidates.

Once a generation's manipulations are completed, new random parents may be created to replace the least fit parents and the process may be repeated. These new parents with their randomness or “genetic diversity” could lead the search down different roads with new efficiencies not yet represented in the existing “fittest” parents.

After a series of generations, the population of remaining parents might display very similar strings of results. This process is known as convergence and might indicate that an optimal or near-optimal solution has been discovered. The result of this process is the “fittest” string which scores strongly on both on the basis of budget and maximizing the proposed objective. This optimal portfolio can then passed to a bid management system which will then implement the changes into the respective pay per click platforms.

As a result, the keyword portfolio management engine 300 may help an advertiser (or their agency) achieve improved results using paid search marketing. Moreover, multiple campaigns can be optimized using different settings. The keyword portfolio management engine 300 may, according to some embodiments, may be transparent regarding how it adjusts bids for keywords, and keywords can be added or removed from an optimized campaign at any time.

The keyword portfolio management engine 300 can, according to some embodiments, scan the competitive environment and its relationship to a campaign's keyword data history multiple times per day and automatically adjust the individual keywords within a campaign to the advertiser's defined objectives and budgets. These scans might, for example, locate and exploit new inefficiencies in the market.

The present invention has been described in terms of several embodiments solely for the purpose of illustration. Persons skilled in the art will recognize from this description that the invention is not limited to the embodiments described.

We claim:

1. A method, comprising:
a. establishing a first set of search keywords;
b. scoring advertising results associated with the first set of search keywords;
c. modifying the first set of search keywords to generate a second set of search keywords;
d. scoring advertising results associated with the second set of search keywords;
e. selecting one of the first and second sets of keywords based at least in part on the advertising results; and
f. modifying the selected set of search keywords to generate a third set of search keywords.

2. The method of claim 1, wherein said modifying is at least partially random.

3. The method of claim 1, wherein scoring advertising results comprises:
a. ranking each of the keywords in the set; and
b. applying a goodness of fit algorithm to obtain the score of the advertising results for each set.

4. A method of optimizing keyword searches, comprising:
a. establishing a first set of search keywords;
b. scoring advertising results associated with the first set of search keywords;
c. establishing a second set of search keywords;
d. scoring advertising results associated with the second set of search keywords;
e. selecting one of the first and the second sets of search keywords based on the advertising results; and
f. generating a third set of search keywords.

5. The method of claim 4, wherein generating a third set of search keywords further comprises modifying the selected first or second set of search keywords.

6. A method of optimizing keyword searches, comprising:
a. creating a series of parent campaigns, wherein the parent campaign is defined as a string of ranks equal to the number of keywords in the parent campaign, wherein each keyword in the campaign has a defined position in the string;
b. evaluating the series of parent campaigns, wherein each parent campaign is compared against a goal and a desired budget; and
c. creating a child campaign based upon the evaluation of the series of parent campaigns.

7. The method of claim 6, wherein evaluating the series of parent campaigns further comprises identifying low performing parents and fit performing parents, and wherein creating a child campaign comprises creating the child campaign from the fit parent campaigns.

8. The method of claim 7, wherein creating the child campaign further comprises merging the string of ranks of the fit performing parents together.

9. The method of claim 7, wherein after the creating the child campaign, comprising the steps of:
a. evaluating the child campaign against the goal and the desired budget; and
b. comparing the evaluation of the child campaign against the evaluations of the fit performing parent.

10. The method of claim 7, wherein, after creating the child campaign, comprising the steps of:
a. introducing new random parent campaigns to replace the low performing parents; and
b. repeating steps a-c.
